(19) United States
(12) Patent Application Publication
(10) Pub. No.: US 2025/0008400 A1
(43) Pub. Date: Jan. 2, 2025

(54) METHOD AND APPARATUS FOR TRAFFIC STEERING IN TERRESTRIAL NETWORK AND NON-TERRESTRIAL NETWORK

(71) Applicant: Electronics and Telecommunications Research Institute, Daejeon (KR)

(72) Inventors: You Sun HWANG, Daejeon (KR); Sook Yang KANG, Daejeon (KR); Jae Sheung SHIN, Daejeon (KR); Jae Wook SHIN, Daejeon (KR); Sung Gu CHOI, Daejeon (KR)

(21) Appl. No.: 18/749,355

(22) Filed: Jun. 20, 2024

(30) Foreign Application Priority Data
Jun. 30, 2023 (KR) 10-2023-0084794
May 3, 2024 (KR) 10-2024-0058999

(51) Int. Cl. H04W 36/08; H04W 36/38; H04W 76/27

(52) U.S. Cl. CPC H04W 36/083; H04W 36/385; H04W 76/27

(57) ABSTRACT

A method of a terminal may comprise: establishing first RRC connections with a first base station and a second base station; in response to a first event condition being satisfied, requesting preparation for first traffic switching by transmitting a first measurement report to the first base station; performing a first RRC reconfiguration procedure with the second base station; releasing the first RRC connection with the first base station; and transitioning to a first RRC-inactive state and a first connection management (CM)-inactive state for the first base station.

### CROSS-REFERENCE TO RELATED APPLICATIONS

This application claims priority to Korean Patent Applications No. 10-2023-0084794, filed on Jun. 30, 2023, and No. 10-2024-0058999, filed on May 3, 2024, with the Korean Intellectual Property Office (KIPO), the entire contents of which are hereby incorporated by reference.

### BACKGROUND

### 1. Technical Field

The present disclosure relates to a traffic steering technique between a terrestrial network and a non-terrestrial network, and more particularly, to a traffic steering technique between a terrestrial network and a non-terrestrial network, which enables a terminal to receive services continuously from a terrestrial base station and a satellite base station.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g., Long Term Evolution (LTE) communication system or LTE-Advanced (LTE-A) communication system), the 5th generation (5G) communication system (e.g., new radio (NR) communication system) that uses a frequency band (e.g., a frequency band of 6 GHz or above) higher than that of the 4G communication system as well as a frequency band of the 4G communication system (e.g., a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Such communication networks can provide communication services to terminals located in terrestrial locations, making them terrestrial networks. Recently, the demand for communication services for unmanned aerial vehicles and satellites located not only in terrestrial locations but also in non-terrestrial locations has been increasing. To address this, technologies for non-terrestrial networks (NTN) are being discussed in the 3GPP. Furthermore, in 3GPP Release-19 (Rel-19), a structure that allows a terminal to simultaneously connect to both a satellite base station and a terrestrial base station is being discussed. In this structure, the terminal can receive services from both the terrestrial and satellite base stations simultaneously. When the terminal receives services from both terrestrial and satellite base stations simultaneously, there may be difficulties or issues with one of the radio connections. In such cases, procedures may be necessary to ensure continuous service for the terminal.

### SUMMARY

The present disclosure for resolving the above-described problems is directed to providing a method and an apparatus for traffic steering between a terrestrial network and a non-terrestrial network, enabling a terminal to continuously receive services from a terrestrial base station and a satellite base station.

According to a first exemplary embodiment of the present disclosure, a method of a terminal may comprise: establishing first radio resource control (RRC) connections with a first base station and a second base station; in response to a first event condition being satisfied, requesting preparation for first traffic switching by transmitting a first measurement report to the first base station; performing a first RRC reconfiguration procedure with the second base station; releasing the first RRC connection with the first base station; and transitioning to a first RRC-inactive state and a first connection management (CM)-inactive state for the first base station, wherein the first traffic switching is a process of switching a first data path through the first base station to a second data path through the second base station.

The performing of the first RRC reconfiguration procedure with the second base station may comprise: receiving a first RRC reconfiguration message from the second base station; establishing a second RRC connection with the second base station according to the first RRC reconfiguration message; and transmitting a first RRC reconfiguration complete message to the second base station.

The first base station may belong to a non-terrestrial network and the second base station may belong to a terrestrial network, or the first base station may belong to a terrestrial network and the second base station may belong to a non-terrestrial network.

The method may further comprise: in response to a second event condition being satisfied, requesting preparation for second traffic switching by transmitting a second measurement report to the second base station; performing a second RRC reconfiguration procedure with the first base station; releasing the first RRC connection with the second base station; and transitioning to a second RRC-inactive state and a second CM-inactive state for the second base station, wherein the second traffic switching is a process of switching the second data path through the second base station to the first data path through the first base station.

The performing of the second RRC reconfiguration procedure with the first base station may comprise: receiving a first paging message from the first base station; performing a radio access network (RAN)-specific resource setup procedure with the first base station; receiving a second RRC reconfiguration message from the first base station; establishing a third RRC connection with the first base station according to the second RRC reconfiguration message; and transmitting a second RRC reconfiguration complete message to the first base station.

The method may further comprise: requesting a service from the first base station, allowing the first base station to prepare for third traffic switching; and requesting a service from the core network, allowing the core network to prepare for fourth traffic switching, wherein the third traffic switching is a process of switching the second data path through the second base station to the first data path through the first base station, and the fourth traffic switching is a process of switching the second data path through the second base station to the first data path through the first base station.

According to a second exemplary embodiment of the present disclosure, a method of a first base station may comprise: establishing a first radio resource control (RRC) connection with a terminal; receiving a first measurement report from the terminal; switching a first data path through the first base station to a second data path through a second base station in cooperation with the second base station and a core network; and releasing the first RRC connection with the terminal.

The method may further comprise: receiving a protocol data unit (PDU) session resume message from the core network; transmitting a paging message to the terminal; receiving a handover command from the core network; performing a first RRC reconfiguration procedure with the terminal; and notifying a handover to the core network.

The first base station may belong to a non-terrestrial network and the second base station may belong to a terrestrial network, or the first base station may belong to a terrestrial network and the second base station may belong to a non-terrestrial network.

The method may further comprise: receiving a service request from the terminal; preparing traffic switching for switching the second data path through the second base station to the first data path through the first base station in cooperation with the second base station and the core network; performing a second RRC reconfiguration procedure with the terminal; and notifying the traffic switching to the core network.

According to a third exemplary embodiment of the present disclosure, a terminal may comprise a processor, and the processor may cause the terminal to perform: establishing first radio resource control (RRC) connections with a first base station and a second base station; in response to a first event condition being satisfied, requesting preparation for first traffic switching by transmitting a first measurement report to the first base station; performing a first RRC reconfiguration procedure with the second base station; releasing the first RRC connection with the first base station; and transitioning to a first RRC-inactive state and a first connection management (CM)-inactive state for the first base station, wherein the first traffic switching is a process of switching a first data path through the first base station to a second data path through the second base station.

In the performing of the first RRC reconfiguration procedure with the second base station, the processor may cause the terminal to perform: receiving a first RRC reconfiguration message from the second base station; establishing a second RRC connection with the second base station according to the first RRC reconfiguration message; and transmitting a first RRC reconfiguration complete message to the second base station.

The processor may further cause the terminal to perform: in response to a second event condition being satisfied, requesting preparation for second traffic switching by transmitting a second measurement report to the second base station; performing a second RRC reconfiguration procedure with the first base station; releasing the first RRC connection with the second base station; and transitioning to a second RRC-inactive state and a second CM-inactive state for the second base station, wherein the second traffic switching is a process of switching the second data path through the second base station to the first data path through the first base station.

In the performing of the second RRC reconfiguration procedure with the first base station, the processor may cause the terminal to perform: receiving a first paging message from the first base station; performing a radio access network (RAN)-specific resource setup procedure with the first base station; receiving a second RRC reconfiguration message from the first base station; establishing a third RRC connection with the first base station according to the second RRC reconfiguration message; and transmitting a second RRC reconfiguration complete message to the first base station.

The processor may further cause the terminal to perform: requesting a service from the first base station, allowing the first base station to prepare for third traffic switching; and requesting a service from the core network, allowing the core network to prepare for fourth traffic switching, wherein the third traffic switching is a process of switching the second data path through the second base station to the first data path through the first base station, and the fourth traffic switching is a process of switching the second data path through the second base station to the first data path through the first base station.

According to the present disclosure, even if a terminal encounters difficulties or issues with one of radio connections while simultaneously receiving services from both a terrestrial base station and a satellite base station, it can continue to receive the services. Additionally, according to the present disclosure, the terminal that is connected to both the terrestrial base station and the satellite base station and receiving services simultaneously can switch to receiving services only from the terrestrial base station depending on specific events or radio channel conditions. Furthermore, according to the present disclosure, the terminal that is connected to both the terrestrial base station and the satellite base station and receiving services simultaneously can switch to receiving services only from the satellite base station depending on specific events or radio channel conditions.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a conceptual diagram illustrating a first exemplary embodiment of a network into which a terrestrial network and a non-terrestrial network are integrated.

FIG. 5 is a conceptual diagram illustrating a second exemplary embodiment of a network into which a terrestrial network and a non-terrestrial network are integrated.

FIG. 6 is a conceptual diagram illustrating a first exemplary embodiment of a traffic steering method in an integrated network of a terrestrial network and a non-terrestrial network.

FIG. 7 is a conceptual diagram illustrating a second exemplary embodiment of a traffic steering method in an integrated network of a terrestrial network and a non-terrestrial network.

FIG. 8 is a sequence chart illustrating a first exemplary embodiment of a traffic steering method in a terrestrial network and a non-terrestrial network.

FIG. 9 is a sequence chart illustrating a second exemplary embodiment of a traffic steering method in a terrestrial network and a non-terrestrial network.

FIG. 10 is a sequence chart illustrating a third exemplary embodiment of a traffic steering method in a terrestrial network and a non-terrestrial network.

FIG. 11 is a sequence chart illustrating a fourth exemplary embodiment of a traffic steering method in a terrestrial network and a non-terrestrial network.

FIG. 12 is a sequence chart illustrating a fifth exemplary embodiment of a traffic steering method in a terrestrial network and a non-terrestrial network.

FIG. 13 is a sequence chart illustrating a sixth exemplary embodiment of a traffic steering method in a terrestrial network and a non-terrestrial network.

FIG. 14 is a sequence chart illustrating a seventh exemplary embodiment of a traffic steering method in a terrestrial network and a non-terrestrial network.

FIG. 15 is a sequence chart illustrating an eighth exemplary embodiment of a traffic steering method in a terrestrial network and a non-terrestrial network.

FIG. 16 is a conceptual diagram illustrating a first exemplary embodiment of state transitions of a terminal.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g., long-term evolution (LTE) communication network), a 5G communication network (e.g., new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

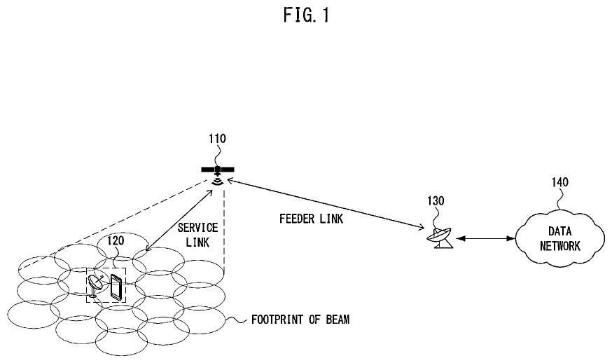

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g., a user equipment (UE) or a terminal) located on a terrestrial site and a communication node (e.g., an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g., downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g., base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g., AMF, UPF, SMF, and the like) may be performed based on an NG-C/U interface.

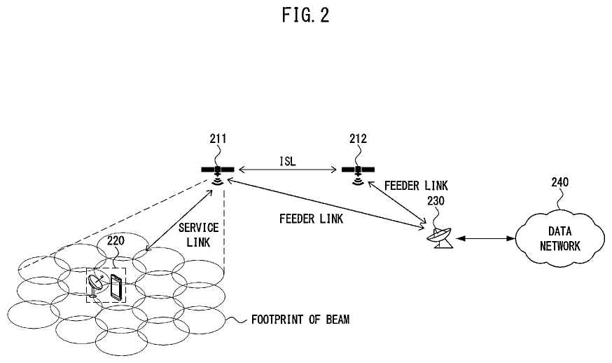

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g., demodulation, decoding, re-encoding, re-modulation, and/or filtering operation) on a payload received from other entities (e.g., the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g., UE or terminal) and a non-terrestrial communication node (e.g., airplane or drone). A service link (e.g., radio link) may be established between the satellite 211 and communication node 220. The satellite 211 may provide communication services to the communication node 220 using one or more beams.

The communication node 220 may perform communications (e.g., downlink communication or uplink communication) with the satellite 211 using LTE technology and/or NR technology. The communications between the satellite 211 and the communication node 220 may be performed using an NR-Uu interface. When DC is supported, the communication node 220 may be connected to other base stations (e.g., base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g., AMF, UPF, SMF, and the like) may be performed based on an NG-C/U interface.

Meanwhile, entities (e.g., satellites, communication nodes, gateways, etc.) constituting the NTNs shown in FIGS. 1 and 2 may be configured as follows.

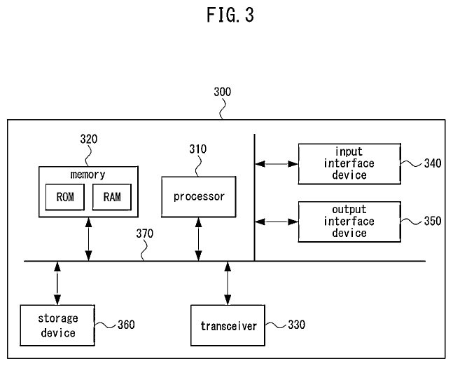

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g., a GEO satellite that supports a transparent function), this may be referred to as ‘scenario A’. When the satellites 211 and 212 in the NTN shown in FIG. 2 are GEO satellites (e.g., GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D32’. Parameters for the scenarios defined in Table 1 may be defined as shown in Table 2 below.

TABLE 2

| | Scenarios A and B | | Scenarios C and D |
|---|---|---|---|
| Altitude | 35,786 | km | 600 km |
| | | | 1,200 km |
| Spectrum (service link) | <6 GHz (e.g., 2 GHz) | | |
| | >6 GHz (e.g., DL 20 GHz, UL 30 GHz) | | |
| Maximum channel bandwidth | 30 MHz for band <6 GHz | | |
| capability | 1 GHz for band >6 GHz | | |
| (service link) | | | |
| Maximum distance between | 40,581 | km | 1,932 km (altitude of 600 km) |
| satellite and communication | | | 3,131 km (altitude of 1,200 km) |
| node (e.g., UE) at the | | | |
| minimum elevation angle | | | |
| Maximum round trip delay | Scenario A: 541.46 ms (service | | Scenario C: (transparent |
| (RTD) | and feeder links) | | payload: service and feeder |
| (only propagation delay) | Scenario B: 270.73 ms (only | | links) −5.77 ms |
| | service link) | | (altitude of 600 km) −41.77 ms |
| | | | (altitude of 1,200 km) |
| | | | Scenario D: (regenerative payload: |
| | | | only service link) −12.89 ms |
| | | | (altitude of 600 km) −20.89 ms |
| | | | (altitude of 1,200 km) |
| Maximum delay variation | 16 | ms | 4.44 ms (altitude of 600 km) |
| within a single beam | | | 6.44 ms (altitude of 1,200 km) |
| Maximum differential delay | 10.3 | ms | 3.12 ms (altitude of 600 km) |
| within a cell | | | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario A | Scenario B | Scenario C1-2 | | Scenario D1-2 | |
|---|---|---|---|---|---|---|
| Satellite altitude | 35,786 km | | 600 km | | | |
| Maximum RTD in a | 541.75 ms | 270.57 ms | 28.41 | ms | 12.88 | ms |
| radio interface between | (worst case) | | | | | |
| base station and UE | | | | | | |
| Minimum RTD in a | 477.14 ms | 238.57 ms | 8 | ms | 4 | ms |
| radio interface between | | | | | | |
| base station and UE | | | | | | |

Meanwhile, mobile communication networks after 5G may be expected to evolve in a direction where terrestrial networks and satellite networks (i.e. non-terrestrial networks (NTNs)) combine or cooperate. Accordingly, in 3GPP Release-19 (Rel-19), a structure that allows a terminal to simultaneously access a satellite base station and a terrestrial base station is being discussed. In this structure, the terminal can simultaneously receive services from the terrestrial base station and the satellite base station.

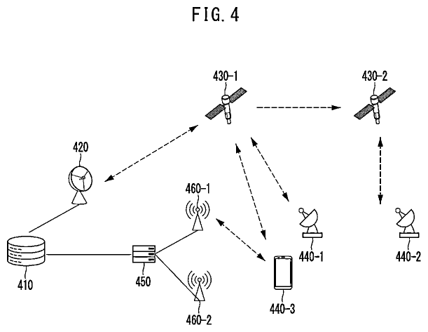

FIG. 4 is a conceptual diagram illustrating a first exemplary embodiment of a network into which a terrestrial network and a non-terrestrial network are integrated.

Referring to FIG. 4, a core network 410 may manage a terrestrial network and a non-terrestrial network (NTN) by integrating them. For this purpose, the core network 410 may be equipped with a network synchronization apparatus. The core network may be a 5G core network or 6G core network. The core network 410 may be connected to a terrestrial station 420 of the NTN (i.e. NTN terrestrial station) by a backhaul. The NTN terrestrial station 420 may be an NTN base station-central unit (e.g. NTN gNB-CU).

The NTN terrestrial station 420 may be connected to a first NTN satellite 430-1 through a midhaul or fronthaul. The first NTN satellite 430-1 may be connected to a second NTN satellite 430-2 through an inter-satellite link (ISL). The first NTN satellite 430-1 and the second NTN satellite 430-2 may each be an NTN base station-distributed unit (e.g. NTN gNB-DU). The NTN terrestrial station 420 may perform functions of an NTN base station together with the first NTN satellite 430-1 and the second NTN satellite 430-2. A form of splitting base station functions between the NTN terrestrial station 420, first NTN satellite 430-1, and second NTN satellite 430-2 may vary depending on an operator's system configuration. The NTN base station may be a non-terrestrial base station or a satellite base station.

In addition, the first NTN satellite 430-1 may be connected to a first terminal 440-1 through a service link or user link. The first NTN satellite 430-1 may be connected to a third terminal 440-3 through a service link or user link. The second NTN satellite 430-2 may be connected to a second terminal 440-2 through a service link or user link. It may be assumed that the service link or user link conforms to the 3GPP NTN technical specifications.

The core network 410 may be connected to a terrestrial network (TN) base station-CU (e.g. TN gNB-CU) 450 through a backhaul. The TN gNB-CU 450 may be connected to a first TN base station-DU/remote unit (RU) (e.g. TN gNB-DU/RU) 460-1 through a midhaul or fronthaul. In addition, the TN gNB-CU 450 may be connected to a second TN gNB-DU/RU 460-2 through a midhaul or fronthaul.

The TN gNB-CU 450 may perform functions of a TN base station together with the first TN gNB-DU/RU 460-1 and the second TN gNB-DU/RU 460-2. A form of splitting base station functions between the TN gNB-CU 450 and the first TN gNB-DU/RU 460-1 may vary depending on the operator's system configuration. In addition, a form of splitting base station functions between the TN gNB-CU 450 and the second TN gNB-DU/RU 460-2 may vary depending on the operator's system configuration. Here, the TN base station may be a terrestrial base station.

The first TN gNB-DU/RU 460-1 may be connected to a third terminal 440-3 through a service link or user link. It may be assumed that the service link or user link conforms to the 3GPP TN technical specifications. When the third terminal 440-3 simultaneously receives services from a terrestrial base station and a satellite base station, a radio connection with one of them may become difficult or a problem therein may occur. In this case, a procedure may be required to ensure that the third terminal 440-3 continues to receive services.

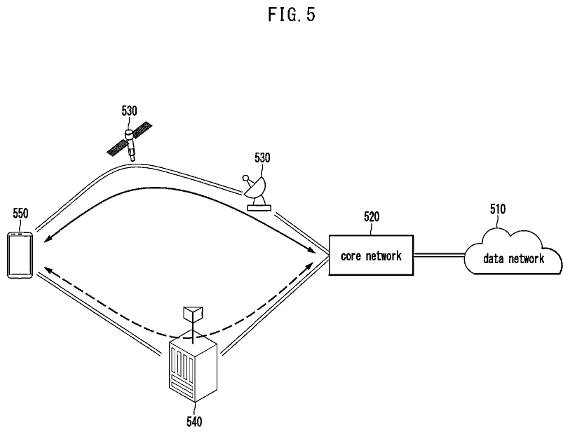

FIG. 5 is a conceptual diagram illustrating a second exemplary embodiment of a network into which a terrestrial network and a non-terrestrial network are integrated.

Referring to FIG. 5, an integrated network of a TN and an NTN may include a data network 510, a core network 520, a satellite base station 530, a terrestrial base station 540, a terminal 550, and the like. In the integrated network, the terminal 550 may be connected to the satellite base station 530 and the terrestrial base station 540. The terminal 550 may receive services from the satellite base station 530 and the terrestrial base station 540 at the same time. For this purpose, the terminal 550 may access one or more public land mobile networks (PLMNs). In addition, the terminal may establish one or more protocol data unit (PDU) sessions. The terminal may receive services through the one or more established PDU sessions via the terrestrial base station 540 and the satellite base station 530.

The terminal 550 may receive services while being being connected to the terrestrial base station 540 and the satellite base station 530 through one established PDU session. Alternatively, the terminal 550 may receive services from the terrestrial base station 540 and the satellite base station 530 through PDU sessions respectively for the terrestrial base station 540 and the satellite base station 530. For example, the terminal 550 may receive services from the terrestrial base station 540 and the satellite base station 530 through their respective PDU sessions.

The terminal 550 connected to two base stations (i.e. the terrestrial base station 540 and the satellite base station 530) at the same time may require a specific procedure to continue receiving services therefrom depending on a radio channel state. Unlike the existing handover procedure, the present disclosure proposes a specific procedure and method for providing service continuity to the terminal 550 connected to the two base stations at the same time. As an example, the present disclosure proposes a specific procedure and method required for the terminal, which is simultaneously connected to and receiving services from the terrestrial base station and the satellite base station, to receive services only from the terrestrial base station according to a specific event or radio channel condition. The present disclosure proposes as a specific procedure and method required for the terminal, which is simultaneously connected to and receiving services from the terrestrial base station and the satellite base station, to receive services only from the satellite base station according to a specific event or radio channel condition.

The 3GPP technical specifications define events for handover and also define a recovery procedure from a problem occurring in a radio channel condition. An operation for the terminal receiving services simultaneously from the terrestrial base station and the satellite base station to receive services only from either one side may be referred to as traffic steering or traffic switching.

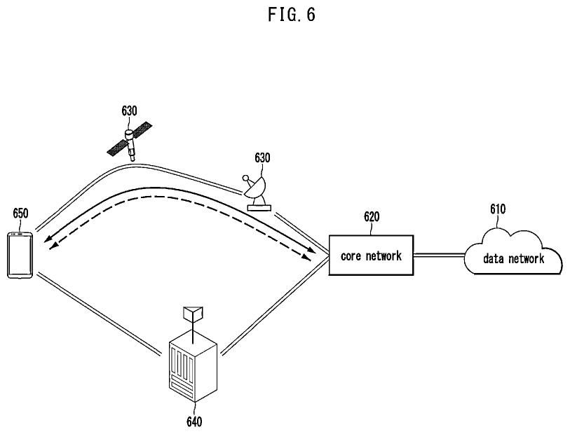

FIG. 6 is a conceptual diagram illustrating a first exemplary embodiment of a traffic steering method in an integrated network of a terrestrial network and a non-terrestrial network.

Referring to FIG. 6, an integrated network of a terrestrial network and a non-terrestrial network may include a data network 610, a core network 620, a satellite base station 630, a terrestrial base station 640, a terminal 650, and the like. In the integrated network, the terminal 650 may perform a traffic steering procedure according to a radio channel condition while receiving services simultaneously from the satellite base station 630 and the terrestrial base station 640 by being connected thereto. Consequently, the terminal 650 may receive services by being connected only to the satellite base station 630.

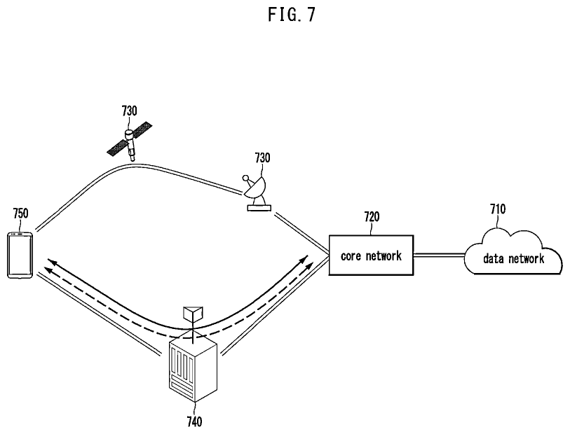

FIG. 7 is a conceptual diagram illustrating a second exemplary embodiment of a traffic steering method in an integrated network of a terrestrial network and a non-terrestrial network.

Referring to FIG. 7, an integrated network of a terrestrial network and a non-terrestrial network may include a data network 710, a core network 720, a satellite base station 730, a terrestrial base station 740, a terminal 750, and the like. In the integrated network, the terminal 750 may perform a traffic steering procedure according to a radio channel condition while receiving services simultaneously from the satellite base station 730 and the terrestrial base station 740 by being connected thereto. Consequently, the terminal 750 may receive services by being connected only to the terrestrial base station 740.

The present disclosure proposes the traffic steering procedure that allows the terminal that simultaneously receives services from the terrestrial base station and the satellite base station to receive the service of the terrestrial base station from the satellite base station, as shown in FIG. 6. The present disclosure proposes the traffic steering procedure that allows the terminal that simultaneously receives services from the terrestrial base station and the satellite base station to receive the service of the satellite base station from the terrestrial base station, as shown in FIG. 7. Hereinafter, the present disclosure will describe, as an example, a traffic steering procedure in which a terminal connected to one core network simultaneously receives services from a satellite base station and a terrestrial base station within one session, and then receives the service of the satellite base station from the terrestrial base station. The traffic steering procedure of the present disclosure may be similarly applied to a procedure for controlling a terminal that has established one or more PDU sessions.

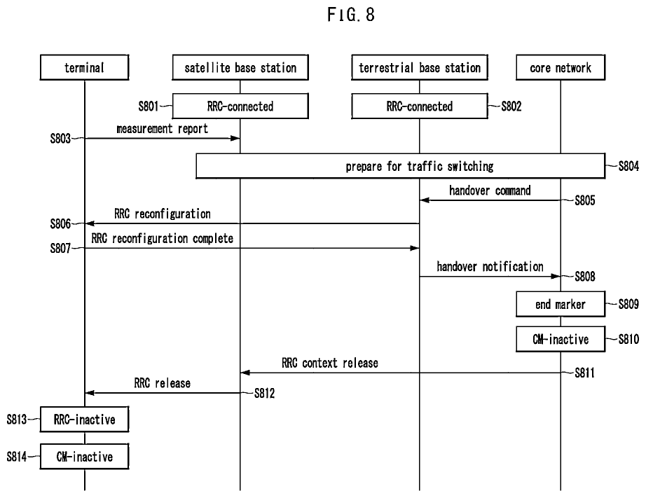

FIG. 8 is a sequence chart illustrating a first exemplary embodiment of a traffic steering method in a terrestrial network and a non-terrestrial network.

Referring to FIG. 8, a terminal may be registered with a terrestrial base station and a satellite base station. The terminal may be in a radio resource control (RRC)-connected state with the terrestrial base station and the satellite base station by establishing one PDU session. The terminal may receive services only from the terrestrial base station by performing a traffic steering procedure.

Describing this in more detail, the terminal may be connected to the satellite base station (S801). Accordingly, the terminal may receive services from the satellite base station while being in the RRC-connected state with the satellite base station. The terminal may be connected to the terrestrial base station (S802). Accordingly, the terminal may receive services from the terrestrial base station while being in the RRC-connected state with the terrestrial base station. The terminal may be in a mobility management (MM)-registered state and a connection management (CM)-connected state with a core network. In other words, the terminal may be connected to and MM-registered with one PLMN. A PDU session may be established with one PDU session identifier (ID) simultaneously for the terrestrial base station and satellite base station. Accordingly, the terminal may be in the CM-connected state.

The satellite base station and terrestrial base station may preconfigure event condition(s) for traffic steering in the terminal. For example, an event condition for traffic steering may correspond to a case where a reception signal strength of the satellite base station becomes less than a specific value. When the event condition(s) are satisfied, the terminal may transmit a measurement report including the reception signal strength of the satellite base station to the satellite base station (S803). The satellite base station may identify the reception signal strength of the satellite base station by receiving the measurement report from the terminal.

An event condition for traffic steering may be a specific time or a specific location of the terminal. The terminal may transmit a measurement report to the satellite base station when the event condition is satisfied by considering an orbit, location, service time, etc. of the satellite base station providing services to the terminal (S803). The satellite base station may receive the measurement report including the satellite base station's orbit, location, service time, etc. from the terminal. The measurement report may include information on a location of the terminal. An event condition for traffic steering may be defined as a traffic steering rule. When the terminal is a terminal capable of being connected to both the satellite base station and the terrestrial base station, the satellite base station may configure the traffic steering rule(s) to the terminal. Additionally and/or alternatively, the terrestrial base station may configure the traffic steering rule(s) to the terminal. The terminal may determine conditions for transmitting a measurement report according to the configured traffic steering condition(s).

The terminal may be connected to the satellite base station and the terrestrial base station of one PLMN. The core network may prepare traffic switching so that a data path between the satellite base station and the terminal is switched to a data path between the terrestrial base station and the terminal (S804). The core network may also configure the path connected with the terminal according to the traffic steering rule(s).

The core network may transmit a handover command (or PDU session modification) message to the terrestrial base station (S805). If the PDU session is established simultaneously for the terrestrial base station and the satellite base station, the core network may transmit, to the terrestrial base station, information on an identifier (ID) of a quality of service (QoS) flow to be added. The terrestrial base station may receive the information on the ID of the QoS flow to be added from the core network. The terrestrial base station may add a new data radio bearer (DRB) if the QoS flow to be added is a new QoS flow when compared to an existing QoS flow configured in the terrestrial base station. The terrestrial base station may maintain configuration of the existing QoS flow if the QoS flow to be added is the same as the existing QoS flow configured in the terrestrial base station. If PDU sessions are configured differently in the terminal for the satellite base station and the terrestrial base station, the terrestrial base station may establish a new PDU session in addition to the existing PDU session.

The terrestrial base station may map the QoS flow ID to a DRB to configure the added QoS flow ID to the terminal. In addition, the terrestrial base station may transmit radio resource allocation information to the terminal by including it in an RRC reconfiguration message (S806). The terminal may receive the RRC reconfiguration message from the terrestrial base station. The terrestrial base station may maintain the existing configuration if QoS configuration parameters are similar to those of the existing QoS flow ID, and may configure a new DRB if they are different. If the PDU sessions are configured differently for the satellite base station and the terrestrial base station, an additional PDU session may be configured for the terminal based on new PDU session information in addition to the existing PDU session.

After applying the added configuration, the terminal may transmit an RRC reconfiguration complete message to the terrestrial base station (S807). The terrestrial base station may confirm completion of the terminal's configuration by receiving the RRC reconfiguration complete message. The terrestrial base station may transmit a handover notification message to the core network (S808). The core network may receive the handover notification message from the terrestrial base station.

The core network may generate an end maker for the data path connected with the satellite base station, and then switch the path to the terrestrial base station (S809). The core network may temporarily maintain information on the terminal's PDU session connected with the satellite base station in a suspended state by transitioning the terminal's state to a CM-inactive state (S810). The CM inactive state may mean a state in which information on the terminal's PDU session is not deleted and the existing configuration is maintained. Unlike the CM idle state (i.e. CM-idle state), the CM-inactive state may maintain information on the PDU session, allowing the terminal to configure the PDU session without performing necessary procedures when configuring the PDU session again later.

The core network may transmit a UE context release message to the satellite base station (S811). In addition, the core network may transmit a non-access stratum (NAS) message to the satellite base station to configure the CM-inactive state to the terminal. The satellite base station may receive the UE context release message from the core network. The satellite base station may transmit an RRC release message to the terminal (S812). The terminal may receive the RRC release message from the satellite base station, transition to an RRC-inactive state (S813), and transition to the CM-inactive state (S814).

The core network may add the CM-inactive state to states for managing the PDU session between the terminal and the core network. When switching the data path from the terrestrial base station to the satellite base station or from the satellite base station to the terrestrial base station through traffic steering, the core network may temporarily maintain the existing PDU session configuration information without deleting it, allowing traffic to be freely transmitted through both the satellite and terrestrial paths. In the CM-inactive state, the core network, satellite base station, terrestrial base station, terminal, and the like may maintain the existing PDU session configuration information, and thus when switching the data path, the existing configuration information may be reused without performing an additional PDU session configuration procedure. The terminal may continue to attempt to transition to the RRC-connected state when uplink data occurs in the RRC-inactive state. The terminal may not perform cell search or radio connection establishment in the CM-inactive state. The core network may configure conditions for cell search and radio connection establishment in the terminal before transitioning to the CM-inactive state. The core network may configure conditions for cell search and radio connection establishment in the terminal in the CM-inactive state. Hereinafter, a procedure for steering traffic from the terrestrial base station to the satellite base station while the terminal is simultaneously connected with the terrestrial base station and the satellite base station will be described.

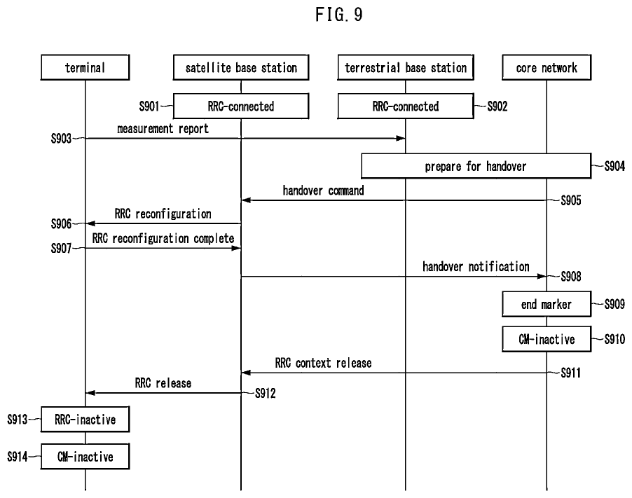

FIG. 9 is a sequence chart illustrating a second exemplary embodiment of a traffic steering method in a terrestrial network and a non-terrestrial network.

Referring to FIG. 9, a terminal may be connected to a satellite base station (S901). The terminal may receive services from the satellite base station while being in the RRC-connected state with the satellite base station. The terminal may be connected to a terrestrial base station (S902). The terminal may receive services from the terrestrial base station while being in the RRC-connected state with the terrestrial base station. The terminal may be in the MM-registered/CM-connected state with a core network. In other words, the terminal may be connected to and MM-registered with one PLMN network. A PDU session may be established simultaneously with the terrestrial base station and the satellite base station using one PDU session ID. Accordingly, the terminal may be in the CM-connected state.

The satellite base station and terrestrial base station may preconfigure event conditions for traffic steering in the terminal. For example, an event condition for traffic steering may correspond to a case when a reception signal strength of the terrestrial base station becomes less than a specific value. If the event condition is satisfied, the terminal may transmit a measurement report including the reception signal strength of the terrestrial base station to the terrestrial base station (S903). The terrestrial base station may receive the measurement report from the terminal to identify the reception signal strength of the terrestrial base station.

An event condition for traffic steering may be a specific time or a specific location of the terminal. Considering an orbit, location, service time, etc. of the satellite base station providing services to the terminal, the terminal may transmit a measurement report to the terrestrial base station when the event condition is satisfied (S903). The terrestrial base station may receive the measurement report including the orbit, location, service time, etc. of the satellite base station from the terminal. The measurement report may include information on the location of the terminal. An event condition for traffic steering may be defined as a traffic steering rule. When the terminal is a terminal capable of being connected to both the satellite base station and the terrestrial base station, the satellite base station may configure the traffic steering rule(s) to the terminal. Additionally and/or alternatively, the terrestrial base station may configure the traffic steering rule(s) to the terminal. The terminal may determine conditions for transmitting a measurement report according to the configured traffic steering condition(s).

The terminal may be connected with the satellite base station and the terrestrial base station of one PLMN. The core network may prepare for a handover so that a data path between the terrestrial base station and the terminal is switched to a data path between the satellite base station and the terminal (S904). The core network may also configure the path connected with the terminal according to the traffic steering rule(s).

The core network may transmit a handover command (or PDU session modification) message to the satellite base station (S905). If the PDU session is established simultaneously for the terrestrial base station and the satellite base station, the core network may transmit, to the satellite base station, information on an ID of a QoS flow to be added. The satellite base station may receive the information on the ID of the QoS flow to be added from the core network. The satellite base station may add a new DRB if the QoS flow to be added is a new QoS flow when compared to an existing QoS flow configured in the satellite base station. The satellite base station may maintain configuration of the existing QoS flow if the QoS flow to be added is the same as the existing QoS flow configured in the satellite base station. If PDU sessions are configured differently for the satellite base station and the terrestrial base station, the terrestrial base station may configure new PDU session information in addition to the existing PDU session.

The satellite base station may map the QoS flow ID to a DRB to configure the added QoS flow ID to the terminal. In addition, the satellite base station may transmit radio resource allocation information to the terminal by including it in an RRC reconfiguration message (S906). The terminal may receive the RRC reconfiguration message from the satellite base station. The satellite base station may maintain the existing configuration if QoS configuration parameters are similar to those of the existing QoS flow ID, and may configure a new DRB if they are different. If the PDU sessions are configured differently for the satellite base station and the terrestrial base station, an additional PDU session may be configured for the terminal based on the new PDU session information in addition to the existing PDU session.

After applying the added configuration, the terminal may transmit an RRC reconfiguration complete message to the satellite base station (S907). The satellite base station may confirm completion of the terminal's configuration by receiving the RRC reconfiguration complete message. The satellite base station may transmit a handover notification message to the core network (S908). The core network may receive the handover notification message from the satellite base station.

The core network may generate an end maker for the data path connected with the terrestrial base station, and then switch the path to the satellite base station (S909). The core network may temporarily maintain information on the terminal's PDU session connected with the terrestrial base station in a suspended state by transitioning the terminal's state to the CM-inactive state (S910). The CM-inactive state may mean a state in which information on the terminal's PDU session is not deleted and the existing configuration is maintained. Unlike the CM-idle state, the CM-inactive state may maintain information on the PDU session, allowing the terminal to configure the PDU session without performing necessary procedures when configuring the PDU session again later.

The core network may transmit a UE context release message to the terrestrial base station (S911). In addition, the core network may transmit a NAS message to the terrestrial base station to configure the CM-inactive state to the terminal. The terrestrial base station may receive the UE context release message from the core network. The terrestrial base station may transmit an RRC release message to the terminal (S912). The terminal may receive the RRC release message from the terrestrial base station, transition to the RRC-inactive state (S913), and transition to the CM-inactive state (S914).

The core network may add the CM-inactive state to states for managing the PDU session between the terminal and the core network. When switching the data path from the terrestrial base station to the satellite base station or from the satellite base station to the terrestrial base station through traffic steering, the core network may temporarily maintain the existing PDU session configuration information without deleting it, allowing traffic to be freely transmitted through both the satellite and terrestrial paths. In the CM-inactive state, the core network, satellite base station, terrestrial base station, terminal, and the like may maintain the existing PDU session configuration information, and thus when switching the data path, the existing configuration information may be reused without performing an additional PDU session configuration procedure. The terminal may continue to attempt to transition to the RRC-connected state when uplink data occurs in the RRC-inactive state. The terminal may not perform cell search or radio connection establishment in the CM-inactive state. The core network may configure conditions for cell search and radio connection establishment in the terminal before transitioning to the CM-inactive state. The core network may configure conditions for cell search and radio connection establishment in the terminal in the CM-inactive state. Hereinafter, a procedure for steering traffic from the terrestrial base station to the satellite base station while the terminal is in the RRC-connected state with the terrestrial base station and is in the RRC-inactive state and CM-inactive sate with the satellite base station will be described.

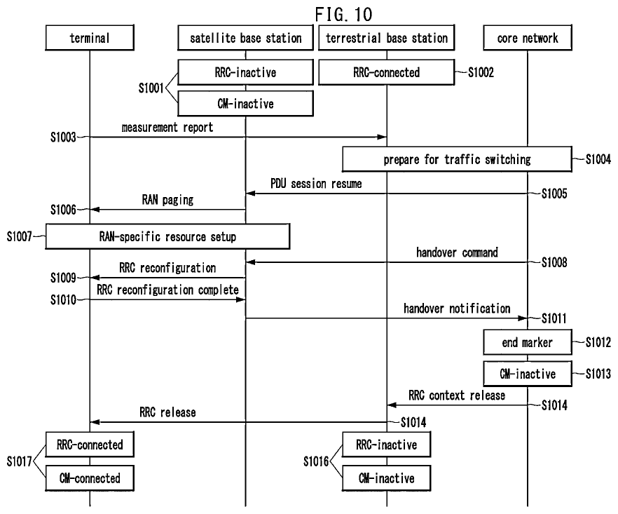

FIG. 10 is a sequence chart illustrating a third exemplary embodiment of a traffic steering method in a terrestrial network and a non-terrestrial network.

Referring to FIG. 10, a terminal may be in the RRC-inactive state and CM-inactive state with the satellite base station (S1001). The terminal may be in the RRC-connected state with a terrestrial base station (S1002). The terminal may receive services from the terrestrial base station while being in the RRC-connected state with the terrestrial base station.

The satellite base station and terrestrial base station may preconfigure event conditions for traffic steering in the terminal. For example, an event condition for traffic steering may correspond to a case when a reception signal strength of the terrestrial base station becomes less than a specific value. If the event condition is satisfied, the terminal may transmit a measurement report including the reception signal strength of the terrestrial base station to the terrestrial base station (S1003). The terrestrial base station may receive the measurement report from the terminal to identify the reception signal strength of the terrestrial base station.

An event condition for traffic steering may be a specific time or a specific location of the terminal. Considering an orbit, location, service time, etc. of the satellite base station providing services to the terminal, the terminal may transmit a measurement report to the terrestrial base station when the event condition is satisfied (S1003). The terrestrial base station may receive the measurement report including the orbit, location, service time, etc. of the satellite base station from the terminal. The measurement report may include information on the location of the terminal. An event condition for traffic steering may be defined as a traffic steering rule. When the terminal is a terminal capable of being connected to both the satellite base station and the terrestrial base station, the satellite base station may configure the traffic steering rule(s) to the terminal. Additionally and/or alternatively, the terrestrial base station may configure the traffic steering rule(s) to the terminal. The terminal may determine conditions for transmitting a measurement report according to the configured traffic steering condition(s).

The terminal may be connected with the satellite base station and the terrestrial base station of one PLMN. The core network may prepare for a handover so that a data path between the terrestrial base station and the terminal is switched to a data path between the satellite base station and the terminal (S1004). The core network may also configure the path connected with the terminal according to the traffic steering rule(s).

The core network may transmit a PDU session resume message to the satellite base station to resume the PDU session of the terminal in the CM-inactive state (S1005). The satellite base station may receive the PDU session resume message from the core network. The satellite base station may transmit a radio access network (RAN) paging message to the terminal in order to connect the terminal in the RRC-inactive state (S1006). The satellite base station may inform the terminal that paging is caused by a PDU session resumption. Depending on a current state of the terminal, the satellite base station may transmit a core network (CN) paging message to the terminal in order to connect the terminal in the RRC-inactive state. The terminal may receive the paging message and perform a radio resource configuration procedure, which is a RAN-specific resource setup procedure for transitioning to the RRC-connected state (S1007).

The core network may transmit a handover command (or PDU session modification) message to the satellite base station (S1008). The core network may transmit a handover command message to the satellite base station including information on resumption of the PDU session and related contents of an ID of a QoS flow connected with the terrestrial base station. The satellite base station may receive the handover command from the core network and receive information on the resumption of the PDU session and the information on the ID of the QoS flow, which is to be added and which was connected with the terrestrial base station. The satellite base station may add a new DRB if the QoS flow to be added is a new QoS flow when compared to an existing QoS flow configured in the satellite base station. The satellite base station may maintain configuration of the existing QoS flow if the QoS flow to be added is the same as the existing QoS flow configured in the satellite base station. If PDU sessions are configured in the terminal differently for the satellite base station and the terrestrial base station, the satellite base station may configure new PDU session information in addition to the existing PDU session.

In order to configure the added QoS flow ID to the terminal, the satellite base station may map the QoS flow ID to a DRB, and transmit radio resource allocation information to the terminal by including it in an RRC reconfiguration message (S1009). The RRC reconfiguration message may include the PDU session resume message. The terminal may receive the RRC reconfiguration message from the satellite base station. The satellite base station may maintain the existing configuration if QoS configuration parameters of the added QoS flow ID are similar to those of the existing QoS flow ID, but may configure a new DRB if they are different. If the PDU sessions are configured in the terminal differently for the satellite base station and the terrestrial base station, an additional PDU session may be configured for the terminal based on the new PDU session information in addition to the existing PDU session.

After applying the added configuration, the terminal may transmit an RRC reconfiguration complete message to the satellite base station (S1010). The satellite base station may confirm completion of the terminal's configuration by receiving the RRC reconfiguration complete message. The satellite base station may transmit a handover notification message to the core network (S1911). The core network may receive the handover notification message from the satellite base station.

The core network may generate an end maker for the data path connected with the terrestrial base station, and then switch the path to the satellite base station (S1012). The core network may temporarily maintain information on the terminal's PDU session connected with the terrestrial base station in a suspended state by transitioning the terminal's state to the CM-inactive state (S1013). The CM-inactive state may mean a state in which information on the terminal's PDU session is not deleted and the existing configuration is maintained. Unlike the CM-idle state, the CM-inactive state may maintain information on the PDU session, allowing the terminal to configure the PDU session without performing necessary procedures when configuring the PDU session again later.

The core network may transmit a UE context release message to the terrestrial base station (S1014). In addition, the core network may transmit a NAS message to the terrestrial base station to configure the CM-inactive state to the terminal. The terrestrial base station may receive the UE context release message from the core network. The terrestrial base station may transmit an RRC release message to the terminal (S1015). The terrestrial base station may transition to the RRC-inactive state and CM-inactive state for the terminal (S1016). The terminal may receive the RRC release message from the terrestrial base station, transition to the RRC-inactive state, and transition to the CM-inactive state (S1017).

The core network may add the CM-inactive state to states for managing the PDU session between the terminal and the core network. When switching the data path from the terrestrial base station to the satellite base station or from the satellite base station to the terrestrial base station through traffic steering, the core network may temporarily maintain the existing PDU session configuration information without deleting it, allowing traffic to be freely transmitted through both the satellite and terrestrial paths. In the CM-inactive state, the core network, satellite base station, terrestrial base station, terminal, and the like may maintain the existing PDU session configuration information, and thus when switching the data path, the existing configuration information may be reused without performing an additional PDU session configuration procedure. The terminal may continue to attempt to transition to the RRC-connected state when uplink data occurs in the RRC-inactive state. The terminal may not perform cell search or radio connection establishment in the CM-inactive state. The core network may configure conditions for cell search and radio connection establishment in the terminal before transitioning to the CM-inactive state. The core network may configure conditions for cell search and radio connection establishment in the terminal in the CM-inactive state. Hereinafter, a procedure for steering traffic from the satellite base station to the terrestrial base station while the terminal is in the RRC-connected state with the satellite base station and is in the RRC-inactive state and CM-inactive sate with the terrestrial base station will be described.

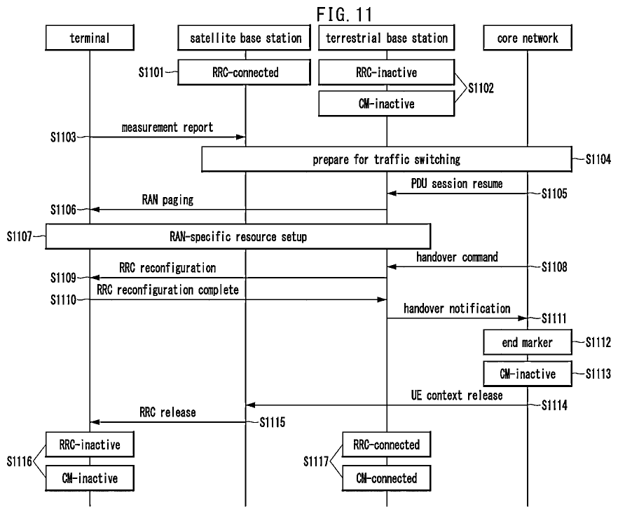

FIG. 11 is a sequence chart illustrating a fourth exemplary embodiment of a traffic steering method in a terrestrial network and a non-terrestrial network.

Referring to FIG. 11, a terminal may be in the RRC-connected state with a satellite base station (S1011). The terminal may be in the RRC-inactive state and CM-inactive state with a terrestrial base station (S1102). The terminal may receive services from the satellite base station while being in the RRC-connected state with the satellite base station.

The satellite base station and terrestrial base station may preconfigure event conditions for traffic steering in the terminal. For example, an event condition for traffic steering may correspond to a case when a reception signal strength of the satellite base station becomes less than a specific value. If the event condition is satisfied, the terminal may transmit a measurement report including the reception signal strength of the satellite base station to the satellite base station (S1103). The satellite base station may receive the measurement report from the terminal to identify the reception signal strength of the satellite base station.

An event condition for traffic steering may be a specific time or a specific location of the terminal. Considering an orbit, location, service time, etc. of the satellite base station providing services to the terminal, the terminal may transmit a measurement report to the satellite base station when the event condition is satisfied (S1103). The measurement report may include information on the location of the terminal. Accordingly, the satellite base station may receive the measurement report including the orbit, location, service time, etc. of the satellite base station from the terminal. An event condition for traffic steering may be defined as a traffic steering rule. When the terminal is a terminal capable of being connected to both the satellite base station and the terrestrial base station, the terrestrial base station may configure the traffic steering rule(s) to the terminal. Additionally and/or alternatively, the satellite base station may configure the traffic steering rule(s) to the terminal. The terminal may determine conditions for transmitting a measurement report according to the configured traffic steering condition(s).

The terminal may be connected with the satellite base station and the terrestrial base station of one PLMN. The core network may prepare for traffic switching so that a data path between the satellite base station and the terminal is switched to a data path between the terrestrial base station and the terminal (S1104). The core network may also configure the path connected with the terminal according to the traffic steering rule(s).

The core network may transmit a PDU session resume message to the terrestrial base station to resume the PDU session of the terminal in the CM-inactive state (S1105). The terrestrial base station may receive the PDU session resume message from the core network. The terrestrial base station may transmit a RAN paging message to the terminal in order to connect the terminal in the RRC-inactive state (S1106). The terrestrial base station may inform the terminal that paging is caused by a PDU session resumption. Depending on a current state of the terminal, the terrestrial base station may transmit a CN paging message to the terminal in order to connect the terminal in the RRC-inactive state. The terminal may receive the paging message and perform a radio resource configuration procedure, which is a RAN-specific resource setup procedure for transitioning to the RRC-connected state (S1107). The RAN-specific resource setup procedure may include a random access procedure and a RRC setup procedure.

The core network may transmit a handover command (or PDU session modification) message to the terrestrial base station (S1108). The core network may transmit the handover command message to the terrestrial base station including information on resumption of the PDU session and related contents of an ID of a QoS flow connected with the satellite base station. The terrestrial base station may receive the handover command from the core network and receive information on the resumption of the PDU session and the information on the ID of the QoS flow, which is to be added and which was connected with the satellited base station. The terrestrial base station may add a new DRB if the QoS flow to be added is a new QoS flow when compared to an existing QoS flow configured in the terrestrial base station. The terrestrial base station may maintain configuration of the existing QoS flow if the QoS flow to be added is the same as the existing QoS flow configured in the terrestrial base station. If PDU sessions are configured in the terminal differently for the satellite base station and the terrestrial base station, the terrestrial base station may configure new PDU session information in addition to the existing PDU session.

In order to configure the added QoS flow ID to the terminal, the terrestrial base station may map the QoS flow ID to a DRB, and transmit radio resource allocation information to the terminal by including it in an RRC reconfiguration message (S1109). The terminal may receive the RRC reconfiguration message from the terrestrial base station. The terrestrial base station may maintain the existing configuration if QoS configuration parameters of the added QoS flow ID are similar to those of the existing QoS flow ID, but may configure a new DRB if they are different. If the PDU sessions are configured in the terminal differently for the satellite base station and the terrestrial base station, an additional PDU session may be configured for the terminal based on the new PDU session information in addition to the existing PDU session.

After applying the added configuration, the terminal may transmit an RRC reconfiguration complete message to the terrestrial base station (S1110). The terrestrial base station may confirm completion of the terminal's configuration by receiving the RRC reconfiguration complete message. The terrestrial base station may transmit a handover notification message to the core network (S1111). The core network may receive the handover notification message from the terrestrial base station. The terrestrial base station may transition to the RRC-inactive state and the CM-inactive state for the terminal (S1117).

The core network may generate an end maker for the data path connected with the satellite base station, and then switch the path to the terrestrial base station (S1112). The core network may transition the terminal's state to the CM-inactive state (S1113). The core network may temporarily maintain information on the terminal's PDU session connected with the satellite base station in a suspended state. The CM-inactive state may mean a state in which information on the terminal's PDU session is not deleted and the existing configuration is maintained. Unlike the CM-idle state, the CM-inactive state may maintain information on the PDU session, allowing the terminal to configure the PDU session without performing necessary procedures when configuring the PDU session again later.

The core network may transmit a UE context release message to the satellite base station (S1114). In addition, the core network may transmit a NAS message to the satellite base station to configure the CM-inactive state to the terminal. The satellite base station may receive the UE context release message from the core network. The satellite base station may transmit an RRC release message to the terminal (S1115). The terminal may receive the RRC release message from the satellite base station, transition to the RRC-inactive state, and transition to the CM-inactive state (S1116).

The core network may add the CM-inactive state to states for managing the PDU session between the terminal and the core network. When switching the data path from the terrestrial base station to the satellite base station or from the satellite base station to the terrestrial base station through traffic steering, the core network may temporarily maintain the existing PDU session configuration information without deleting it, allowing traffic to be freely transmitted through both the satellite and terrestrial paths. In the CM-inactive state, the core network, satellite base station, terrestrial base station, terminal, and the like may maintain the existing PDU session configuration information, and thus when switching the data path, the existing configuration information may be reused without performing an additional PDU session configuration procedure. The terminal may continue to attempt to transition to the RRC-connected state when uplink data occurs in the RRC-inactive state. The terminal may not perform cell search or radio connection establishment in the CM-inactive state. The core network may configure conditions for cell search and radio connection establishment in the terminal before transitioning to the CM-inactive state. The core network may configure conditions for cell search and radio connection establishment in the terminal in the CM-inactive state. Hereinafter, a procedure for steering traffic from the satellite base station to the terrestrial base station while the terminal is in the RRC-connected state with the satellite base station and is in the RRC-inactive state and CM-inactive sate with the terrestrial base station will be described.

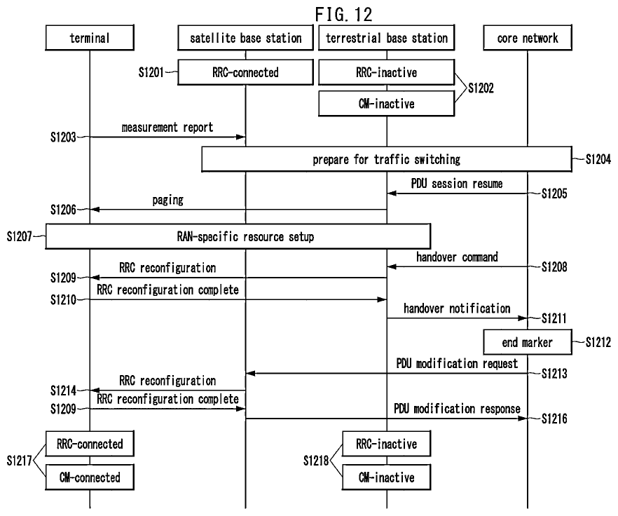

FIG. 12 is a sequence chart illustrating a fifth exemplary embodiment of a traffic steering method in a terrestrial network and a non-terrestrial network.

Referring to FIG. 12, a terminal may be in the RRC-connected state with a satellite base station (S1211). The terminal may be in the RRC-inactive state and CM-inactive state with a terrestrial base station (S1202). The terminal may receive services from the satellite base station while being in the RRC-connected state with the satellite base station.

The satellite base station and terrestrial base station may preconfigure event conditions for traffic steering in the terminal. For example, an event condition for traffic steering may correspond to a case when a reception signal strength of the satellite base station becomes less than a specific value. If the event condition is satisfied, the terminal may transmit a measurement report including the reception signal strength of the satellite base station to the satellite base station (S1203). The satellite base station may receive the measurement report from the terminal to identify the reception signal strength of the satellite base station.

An event condition for traffic steering may be a specific time or a specific location of the terminal. Considering an orbit, location, service time, etc. of the satellite base station providing services to the terminal, the terminal may transmit a measurement report to the satellite base station when the event condition is satisfied (S1203). The measurement report may include information on the location of the terminal. Accordingly, the satellite base station may receive the measurement report including the orbit, location, service time, etc. of the satellite base station from the terminal. An event condition for traffic steering may be defined as a traffic steering rule. When the terminal is a terminal capable of being connected to both the satellite base station and the terrestrial base station, the terrestrial base station may configure the traffic steering rule(s) to the terminal. Additionally and/or alternatively, the satellite base station may configure the traffic steering rule(s) to the terminal. The terminal may determine conditions for transmitting a measurement report according to the configured traffic steering condition(s).

The terminal may be connected with the satellite base station and the terrestrial base station of one PLMN. The core network may prepare for traffic switching so that a data path between the satellite base station and the terminal is switched to a data path between the terrestrial base station and the terminal (S1204). The core network may also configure the path connected with the terminal according to the traffic steering rule(s).

The core network may transmit a PDU session resume message to the terrestrial base station to resume the PDU session of the terminal in the CM-inactive state (S1205). The terrestrial base station may receive the PDU session resume message from the core network. The terrestrial base station may transmit a RAN paging message to the terminal in order to connect the terminal in the RRC-inactive state (S1206). The terrestrial base station may inform the terminal that paging is caused by a PDU session resumption. Depending on a current state of the terminal, the terrestrial base station may transmit a CN paging message to the terminal in order to connect the terminal in the RRC-inactive state. The terminal may receive the paging message and perform a radio resource configuration procedure, which is a RAN-specific resource setup procedure for transitioning to the RRC-connected state (S1207). The RAN-specific resource setup procedure may include a random access procedure and a RRC setup procedure.

The core network may transmit a handover command (or PDU session modification) message to the terrestrial base station (S1208). The core network may transmit the handover command message to the terrestrial base station including information on resumption of the PDU session and related contents of an ID of a QoS flow connected with the satellite base station. The terrestrial base station may receive the handover command from the core network and receive information on the resumption of the PDU session and the information on the ID of the QoS flow which is to be added and which was connected with the satellited base station. The terrestrial base station may add a new DRB if the QoS flow to be added is a new QoS flow when compared to an existing QoS flow configured in the terrestrial base station. The terrestrial base station may maintain configuration of the existing QoS flow if the QoS flow to be added is the same as the existing QoS flow configured in the terrestrial base station. If PDU sessions are configured in the terminal differently for the satellite base station and the terrestrial base station, the terrestrial base station may configure new PDU session information in addition to the existing PDU session.

In order to configure the added QoS flow ID to the terminal, the terrestrial base station may map the QoS flow ID and a DRB, and transmit radio resource allocation information to the terminal by including it in an RRC reconfiguration message (S1209). The terminal may receive the RRC reconfiguration message from the terrestrial base station. The terrestrial base station may maintain the existing configuration if QoS configuration parameters of the added QoS flow ID are similar to those of the existing QoS flow ID, but may configure a new DRB if they are different. If the PDU sessions are configured in the terminal differently for the satellite base station and the terrestrial base station, an additional PDU session may be configured for the terminal based on the new PDU session information in addition to the existing PDU session.

After applying the added configuration, the terminal may transmit an RRC reconfiguration complete message to the terrestrial base station (S1210). The terrestrial base station may confirm completion of the terminal's configuration by receiving the RRC reconfiguration complete message. The terrestrial base station may transmit a handover notification message to the core network (S1211). The core network may receive the handover notification message from the terrestrial base station. The terrestrial base station may transition to the RRC-inactive state and the CM-inactive state for the terminal (S1218).

The core network may generate an end maker for the data path connected with the satellite base station, and then switch the path to the terrestrial base station (S1212). The core network may transmit a PDU modification request message to the satellite base station (S1213). The satellite base station may receive the PDU modification request message from the core network. The satellite base station may transmit an RRC reconfiguration message to the terminal (S1214).

The terminal may receive the RRC reconfiguration message from the satellite base station, transition to the RRC connected state, and transition to the CM-connected state (S1217). The terminal may transmit an RRC reconfiguration complete message to the satellite base station (S1215). The satellite base station may receive the RRC reconfiguration complete message from the terminal. Accordingly, the satellite may transmit a PDU modification response message to the core network (S1216). The core network may receive the PDU modification response message from the satellite base station. When the terrestrial base station reaches a connectable state while the terminal is receiving services only from the satellite base station, the terminal may establish an RRC connection with the terrestrial base station. In this case, services from the satellite base station may be maintained. Hereinafter, a procedure for steering traffic from the terrestrial base station to the satellite base station when the terminal is in the RRC connected state with the terrestrial base station and is in the RRC-inactive state and the CM-inactive state with the satellite base station will be described.

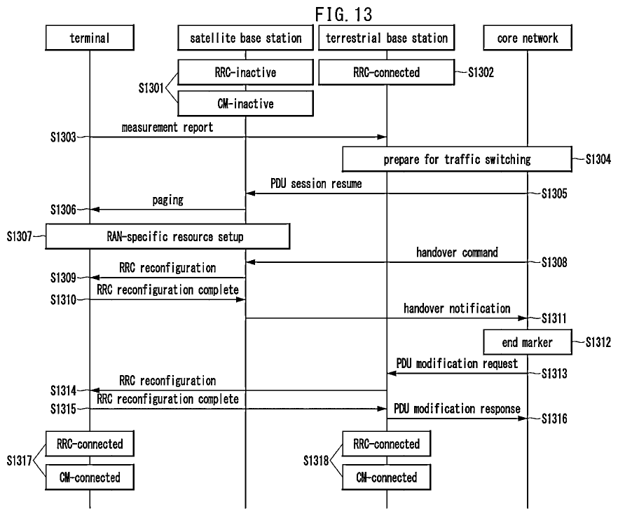

FIG. 13 is a sequence chart illustrating a sixth exemplary embodiment of a traffic steering method in a terrestrial network and a non-terrestrial network.

Referring to FIG. 13, a terminal may be in the RRC-connected state and the CM-inactive state with a satellite base station (S1301). The terminal may be in the RRC-connected state with a terrestrial base station (S1302). The terminal may receive services from the terrestrial base station while being in the RRC-connected state with the terrestrial base station.

The satellite base station and terrestrial base station may preconfigure event conditions for traffic steering in the terminal. For example, an event condition for traffic steering may correspond to a case when a reception signal strength of the terrestrial base station becomes less than a specific value. If the event condition is satisfied, the terminal may transmit a measurement report including the reception signal strength of the terrestrial base station to the terrestrial base station (S1303). The terrestrial base station may receive the measurement report from the terminal to identify the reception signal strength of the terrestrial base station.

An event condition for traffic steering may be a specific time or a specific location of the terminal. Considering an orbit, location, service time, etc. of the satellite base station providing services to the terminal, the terminal may transmit a measurement report to the terrestrial base station when the event condition is satisfied (S1303). The terrestrial base station may receive the measurement report including the orbit, location, service time, etc. of the satellite base station from the terminal. The measurement report may include information on the location of the terminal. An event condition for traffic steering may be defined as a traffic steering rule. When the terminal is a terminal capable of being connected to both the satellite base station and the terrestrial base station, the terrestrial base station may configure the traffic steering rule(s) to the terminal. Additionally and/or alternatively, the satellite base station may configure the traffic steering rule(s) to the terminal. The terminal may determine conditions for transmitting a measurement report according to the configured traffic steering condition(s).

The terminal may be connected with the satellite base station and the terrestrial base station of one PLMN. The core network may prepare for traffic switching so that a data path between the terrestrial base station and the terminal is switched to a data path between the satellite base station and the terminal (S1304). The core network may also configure the path connected with the terminal according to the traffic steering rule(s).

The core network may transmit a PDU session resume message to the satellite base station to resume the a PDU session of the terminal in the CM-inactive state (S1305). The satellite base station may receive the PDU session resume message from the core network. The satellite base station may transmit a paging message to the terminal in order to connect the terminal in the RRC-inactive state (S1306).

The satellite base station may inform the terminal that paging is caused by a PDU session resumption. Depending on a current state of the terminal, the satellite base station may transmit a CN paging message to the terminal in order to connect the terminal in the-RRC inactive state. The terminal may receive the paging message and perform a radio resource configuration procedure, which is a RAN-specific resource setup procedure for transitioning to the RRC-connected state (S1307). The RAN-specific resource setup procedure may include a random access procedures and an RRC setup procedure.

The core network may transmit a handover command (or PDU session modification) message to the satellite base station (S1308). The core network may transmit the handover command message to the satellite base station including information on resumption of the PDU session and related contents of an ID of a QoS flow connected with the terrestrial base station. The satellite base station may receive the handover command from the core network and receive information on the resumption of the PDU session and the information on the ID of the QoS flow, which is to be added and which was connected with the terrestrial base station. The satellite base station may add a new DRB if the QoS flow to be added is a new QoS flow when compared to a QoS flow configured in the terrestrial base station. The satellite base station may maintain configuration of the existing QoS flow if the QoS flow to be added is the same as the existing QoS flow configured in the satellite base station. If PDU sessions are configured in the terminal differently for the satellite base station and the terrestrial base station, the satellite base station may configure new PDU session information in addition to the existing PDU session.

In order to configure the added QoS flow ID to the terminal, the satellite base station may map the QoS flow ID to a DRB, and transmit radio resource allocation information to the terminal by including it in an RRC reconfiguration message (S1309). The terminal may receive the RRC reconfiguration message from the satellite base station. The satellite base station may maintain the existing configuration if QoS configuration parameters of the added QoS flow ID are similar to those of the existing QoS flow ID, but may configure a new DRB if they are different. If the PDU sessions are configured in the terminal differently for the satellite base station and the terrestrial base station, an additional PDU session may be configured for the terminal based on the new PDU session information in addition to the existing PDU session.

After applying the added configuration, the terminal may transmit an RRC reconfiguration complete message to the satellite base station (S1310). The satellite base station may confirm completion of the terminal's configuration by receiving the RRC reconfiguration complete message. The satellite base station may transmit a handover notification message to the core network (S1311). The core network may receive the handover notification message from the satellite base station.

The core network may generate an end maker for the data path connected with the terrestrial base station, and then switch the path to the satellite base station (S1312). The core network may transmit a PDU modification request message to the terrestrial base station (S1309). The terrestrial base station may receive the PDU modification request message from the core network. The terrestrial base station may transmit an RRC reconfiguration message to the terminal (S1310).

The terrestrial base station may maintain the RRC connected state and the CM connected state with the terminal (S1318). The terminal may receive the RRC reconfiguration message from the terrestrial base station, transition to the RRC-connected state, and transition to the CM-connected state (S1317). After reflecting the configuration, the terminal may transmit an RRC reconfiguration complete message to the terrestrial base station (S1315). The terrestrial base station may receive the RRC reconfiguration complete message from the terminal. The terrestrial base station may transmit a PDU modification response message to the core network (S1316). The core network may receive the PDU modification response message from the terrestrial base station. When the satellite base station reaches a connectable state while the terminal is receiving services only from the terrestrial base station, the terminal may establish an RRC connection with the satellite base station. The terrestrial base station may be in the RRC-connected state with the terminal. Hereinafter, a procedure for steering traffic from the terrestrial base station to the satellite base station when the terminal is in the RRC connected state with the terrestrial base station and is in the RRC-inactive state and the CM-inactive state with the satellite base station will be described.

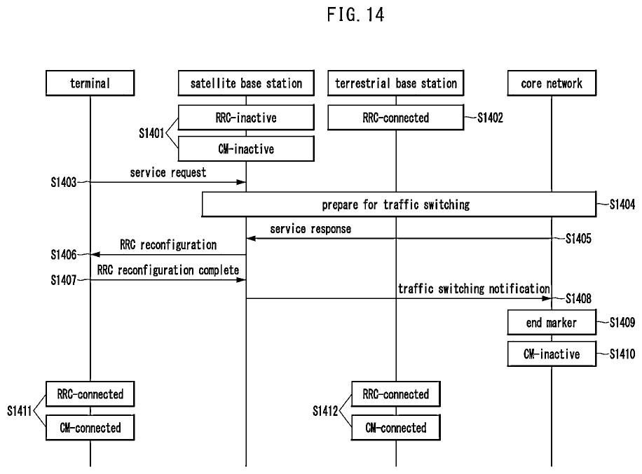

FIG. 14 is a sequence chart illustrating a seventh exemplary embodiment of a traffic steering method in a terrestrial network and a non-terrestrial network.

Referring to FIG. 14, a terminal may be in the RRC-inactive state and the CM-inactive state with a satellite base station (S1401). The terminal may be in the RRC-connected state with a terrestrial base station (S1402). The terminal may receive services from the terrestrial base station while being in the RRC-connected state with the terrestrial base station.

The satellite base station may preconfigure conditions for requesting services in the terminal. The terminal in the RRC-inactive/CM-inactive state with the satellite base station may search for an appropriate satellite base station and transmit a service request message to the satellite base station (S1403). In the process of searching for the satellite base station, the terminal may determine whether to connect to the satellite base station by considering battery consumption or channel state. The satellite base station may receive the service request message from the terminal.

The terminal may be connected with the satellite base station and the terrestrial base station of one PLMN. The core network may prepare for traffic switching so that a data path between the terrestrial base station and the terminal is switched to a data path between the satellite base station and the terminal (S1404). The core network may also configure the path connected with the terminal according to the traffic steering rule(s).

The core network may transmit a service response message for resuming a PDU session of the terminal in the CM-inactive state to the satellite base station (S1405). The satellite base station may receive the service response message requesting to resume the PDU session from the core network. The satellite base station may transmit an RRC reconfiguration message to the terminal in order to connect the terminal in the RRC-inactive state (S1406). The RRC reconfiguration message may be a service response message to the terminal's service request message. The terminal may receive the RRC reconfiguration message and perform a radio resource configuration procedure, which is a RAN-specific resource setup procedure to transition to the RRC-connected state. The RAN-specific resource setup procedure may include a random access procedure and an RRC setup procedure.

After applying the added configuration, the terminal may transmit an RRC reconfiguration complete message to the satellite base station (S1407). The satellite base station may confirm completion of the terminal's configuration by receiving the RRC reconfiguration complete message. The satellite base station may transmit a traffic switching notification message to the core network (S1408). The core network may receive the traffic switching notification message from the satellite base station. The core network may transition to the CM-connected state for the terminal (S1410).

The core network may generate an end maker for the data path connected with the terrestrial base station, and then switch the path to the satellite base station (S1409). The terminal may transition to the RRC-connected state and transition to the CM-connected state (S1411). The terrestrial base station may maintain the RRC-connected state and transition to the CM-connected state (S1412). Hereinafter, a procedure for steering traffic from the satellite base station to the terrestrial base station when the terminal is in the RRC-connected state with the satellite base station, and is in the RRC-inactive state and the CM-inactive state with the terrestrial base station will be described.

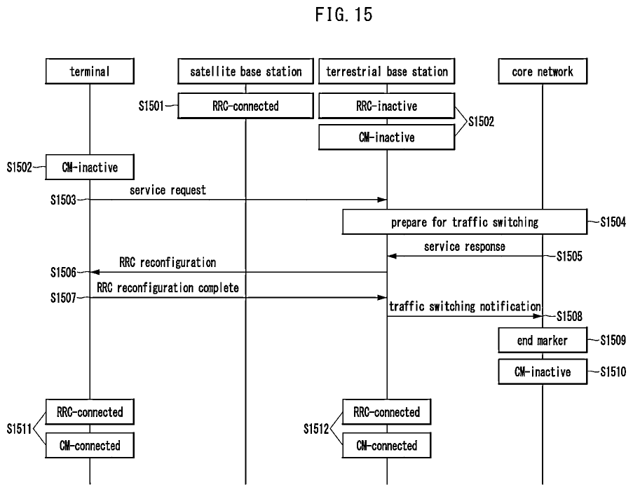

FIG. 15 is a sequence chart illustrating an eighth exemplary embodiment of a traffic steering method in a terrestrial network and a non-terrestrial network.

Referring to FIG. 15, a terminal may be in the RRC-connected state with a satellite base station (S1501). The terminal may be in the RRC-inactive state and the CM-inactive state with a terrestrial base station (S1502). The terminal may receive services from the satellite base station while being in the RRC-connected state with the satellite base station.

The terrestrial base station may preconfigure conditions for requesting services in the terminal. The terminal in the RRC-inactive/CM-inactive state with the terrestrial base station may search for an appropriate terrestrial base station and transmit a service request message to the core network (S1503). In the process of searching for the terrestrial base station, the terminal may determine whether to connect to the terrestrial base station by considering battery consumption or channel state. The core network may receive the service request message from the terminal.

The terminal may be connected with the satellite base station and the terrestrial base station of one PLMN. The core network may prepare for traffic switching so that a data path between the satellite base station and the terminal is switched to a data path between the terrestrial base station and the terminal (S1504). The core network may also configure the path connected with the terminal according to the traffic steering rule(s).

The core network may transmit a service response message for resuming a PDU session of the terminal in the CM-inactive state to the terrestrial base station (S1505). The terrestrial base station may receive the service response message requesting to resume the PDU session from the core network. The terrestrial base station may transmit an RRC reconfiguration message to the terminal in order to connect the terminal in the RRC-inactive state (S1506). The RRC reconfiguration message may be a service response message to the terminal's service request message. The terminal may receive the RRC reconfiguration message and perform a radio resource configuration procedure, which is a RAN-specific resource setup procedure to transition to the RRC-connected state. The RAN-specific resource setup procedure may include a random access procedure and an RRC setup procedure.

After applying the added configuration, the terminal may transmit an RRC reconfiguration complete message to the terrestrial base station (S1507). The terrestrial base station may confirm completion of the terminal's configuration by receiving the RRC reconfiguration complete message. The terrestrial base station may transmit a traffic switching notification message to the core network (S1508). The core network may receive the traffic switching notification message from the terrestrial base station.

The core network may generate an end maker for the data path connected with the satellite base station, and then switch the path to the terrestrial base station (S1509). The core network may transition to the CM-connected state for the terminal (S1510). The terminal may transition to the RRC-connected state and CM-connected state (S1511). The terrestrial base station may also transition to the RRC-connected state and the CM-connected state (S1512).

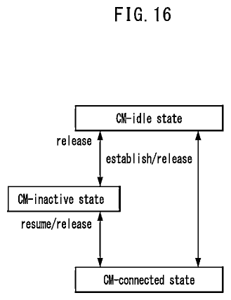

FIG. 16 is a conceptual diagram illustrating a first exemplary embodiment of state transitions of a terminal.

Referring to FIG. 16, a terminal may transition from the CM-idle state to the CM-connected state through an establishment procedure. The terminal may transition from the CM-connected state to the CM-idle state through a release procedure. The terminal may transition from the CM-idle state to the CM-inactive state. The terminal may transition from the CM-inactive state to the CM-idle state through a release procedure. The terminal may transition from the CM-inactive state to the CM-connected state through a resume procedure. The terminal may transition from the CM-connected state to the CM-inactive state through a release procedure.

When steering traffic between the satellite and terrestrial base stations, since using the existing PDU configuration information may simplify signaling procedures, defining the CM-inactive state may be necessary. By defining the CM-inactive state in the terminal, the terminal can avoid unnecessary base station searches or radio access procedures, thereby saving power in the terminal. Although FIGS. 8 to 15 have described the procedures when establishing one PDU session with one PLMN. FIGS. 8 to 15 may be applied also to a case of establishing one or more PDU sessions with one or more PLMNs. The procedures of FIGS. 8 to 15 may be expanded and configured to include an inter-PLMN configuration procedure and a PDU session addition procedure.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
establishing first radio resource control (RRC) connections with a first base station and a second base station;
in response to a first event condition being satisfied, requesting preparation for first traffic switching by transmitting a first measurement report to the first base station;
performing a first RRC reconfiguration procedure with the second base station;
releasing the first RRC connection with the first base station; and
transitioning to a first RRC-inactive state and a first connection management (CM)-inactive state for the first base station,
wherein the first traffic switching is a process of switching a first data path through the first base station to a second data path through the second base station.

2. The method according to claim 1, wherein the performing of the first RRC reconfiguration procedure with the second base station comprises:
receiving a first RRC reconfiguration message from the second base station;
establishing a second RRC connection with the second base station according to the first RRC reconfiguration message; and
transmitting a first RRC reconfiguration complete message to the second base station.

3. The method according to claim 1, wherein the first base station belongs to a non-terrestrial network and the second base station belongs to a terrestrial network, or the first base station belongs to a terrestrial network and the second base station belongs to a non-terrestrial network.

4. The method according to claim 1, further comprising:
in response to a second event condition being satisfied, requesting preparation for second traffic switching by transmitting a second measurement report to the second base station;
performing a second RRC reconfiguration procedure with the first base station;
releasing the first RRC connection with the second base station; and
transitioning to a second RRC-inactive state and a second CM-inactive state for the second base station,
wherein the second traffic switching is a process of switching the second data path through the second base station to the first data path through the first base station.

5. The method according to claim 1, wherein the performing of the second RRC reconfiguration procedure with the first base station comprises:
receiving a first paging message from the first base station;
performing a radio access network (RAN)-specific resource setup procedure with the first base station;
receiving a second RRC reconfiguration message from the first base station;
establishing a third RRC connection with the first base station according to the second RRC reconfiguration message; and
transmitting a second RRC reconfiguration complete message to the first base station.

6. The method according to claim 1, further comprising:
requesting a service from the first base station, allowing the first base station to prepare for third traffic switching; and
requesting a service from the core network, allowing the core network to prepare for fourth traffic switching,
wherein the third traffic switching is a process of switching the second data path through the second base station to the first data path through the first base station, and the fourth traffic switching is a process of switching the second data path through the second base station to the first data path through the first base station.

7. A method of a first base station, comprising:
establishing a first radio resource control (RRC) connection with a terminal;
receiving a first measurement report from the terminal;
switching a first data path through the first base station to a second data path through a second base station in cooperation with the second base station and a core network; and
releasing the first RRC connection with the terminal.

8. The method according to claim 7, further comprising:
receiving a protocol data unit (PDU) session resume message from the core network;
transmitting a paging message to the terminal;
receiving a handover command from the core network;
performing a first RRC reconfiguration procedure with the terminal; and
notifying a handover to the core network.

9. The method according to claim 7, wherein the first base station belongs to a non-terrestrial network and the second base station belongs to a terrestrial network, or the first base station belongs to a terrestrial network and the second base station belongs to a non-terrestrial network.

10. The method according to claim 7, further comprising:
receiving a service request from the terminal;
preparing traffic switching for switching the second data path through the second base station to the first data path through the first base station in cooperation with the second base station and the core network;
performing a second RRC reconfiguration procedure with the terminal; and
notifying the traffic switching to the core network.

11. A terminal comprising a processor, wherein the processor causes the terminal to perform:
establishing first radio resource control (RRC) connections with a first base station and a second base station;
in response to a first event condition being satisfied, requesting preparation for first traffic switching by transmitting a first measurement report to the first base station;
performing a first RRC reconfiguration procedure with the second base station;
releasing the first RRC connection with the first base station; and
transitioning to a first RRC-inactive state and a first connection management (CM)-inactive state for the first base station,
wherein the first traffic switching is a process of switching a first data path through the first base station to a second data path through the second base station.

12. The terminal according to claim 11, wherein in the performing of the first RRC reconfiguration procedure with the second base station, the processor causes the terminal to perform: receiving a first RRC reconfiguration message from the second base station;
establishing a second RRC connection with the second base station according to the first RRC reconfiguration message; and
transmitting a first RRC reconfiguration complete message to the second base station.

13. The terminal according to claim 11, wherein the processor further causes the terminal to perform:
in response to a second event condition being satisfied, requesting preparation for second traffic switching by transmitting a second measurement report to the second base station;
performing a second RRC reconfiguration procedure with the first base station;
releasing the first RRC connection with the second base station; and
transitioning to a second RRC-inactive state and a second CM-inactive state for the second base station,
wherein the second traffic switching is a process of switching the second data path through the second base station to the first data path through the first base station.

14. The terminal according to claim 13, wherein in the performing of the second RRC reconfiguration procedure with the first base station, the processor causes the terminal to perform:
receiving a first paging message from the first base station;
performing a radio access network (RAN)-specific resource setup procedure with the first base station;
receiving a second RRC reconfiguration message from the first base station;
establishing a third RRC connection with the first base station according to the second RRC reconfiguration message; and
transmitting a second RRC reconfiguration complete message to the first base station.

15. The terminal according to claim 11, wherein the processor further causes the terminal to perform:
requesting a service from the first base station, allowing the first base station to prepare for third traffic switching; and
requesting a service from the core network, allowing the core network to prepare for fourth traffic switching,
wherein the third traffic switching is a process of switching the second data path through the second base station to the first data path through the first base station, and the fourth traffic switching is a process of switching the second data path through the second base station to the first data path through the first base station.
